(19) United States
(12) Patent Application Publication
(10) Pub. No.: US 2011/0194040 A1
(43) Pub. Date: Aug. 11, 2011

(54) AUTO LIGHT-SHADING SYSTEM

(75) Inventor: Chih-Fang CHEN, Miaoli County (TW)

(73) Assignee: Du Pont Apollo Limited, Hong Kong (HK)

(21) Appl. No.: 13/015,557

(22) Filed: Jan. 27, 2011

Related U.S. Application Data
(60) Provisional application No. 61/302,264, filed on Feb. 8, 2010.

(51) Int. Cl. G02F 1/1335; G03B 21/56

(52) U.S. Cl. 349/16; 359/450

(57) ABSTRACT

An auto light-shading system is disclosed, which includes a photovoltaic module for providing an electric power, a liquid crystal panel connected to and driven by the photovoltaic module, and a UV filter applied on the liquid crystal panel. A light transmittance of the light-shading device is determined by an output power of the electric power of the photovoltaic module.

### RELATED APPLICATIONS

This application claims priority to U.S. Provisional Application Ser. No. 61/302,264, filed Feb. 8, 2010, which is herein incorporated by reference.

### BACKGROUND

1. Field of Invention

The present invention relates to a light-shading device. More particularly, the present invention relates to an auto light-shading system.

2. Description of Related Art

The conventional light-shading device may be a blind or a curtain. The light-shading device can be disposed at the window to prevent unwanted sunlight passing through the window and entering the building directly. However, the convention light-shading device is operated manually but not automatically, thus the light transmittance cannot be adjusted with intensity of sunlight rapidly. Furthermore, the light shading function would not be worked when there is nobody in the building.

Therefore, there is a need to provide an auto light-shading system.

### SUMMARY

An embodiment of the invention provides an auto light-shading system, which includes a photovoltaic module for providing an electric power, and a light-shading device connected to and driven by the photovoltaic module. A light transmittance of the light-shading device is determined by an output power of the electric power of the photovoltaic module.

The auto light-shading system may further include a regulator connected to the photovoltaic module and the light-shading device, wherein the electric power can be transmitted to the light-shading device via the regulator. The auto light-shading system may further include a power storage connected to the regulator, wherein a part of the electric power can be transmitted to the light-shading device via the regulator, and another part of the electric power can be transmitted to the power storage via the regulator. The light-shading device can be an electric blind, an electric curtain, or a liquid crystal panel.

Another embodiment of the auto light-shading system includes a photovoltaic module for providing an electric power, a liquid crystal panel connected to and driven by the photovoltaic module, and a UV filter applied on the liquid crystal panel. A light transmittance of the light-shading device is determined by an output power of the electric power of the photovoltaic module.

The liquid crystal panel includes a first polarizer, a second polarizer, two substrates, and a liquid crystal layer. The liquid crystal layer is sandwiched between the substrates, and the first and second polarizers are arranged at opposite sides of the substrates. At least one of the substrate is connected to the photovoltaic module. Each substrate may have a pattern. The liquid crystal panel can be a normally white type liquid crystal panel. The liquid crystal panel can be a normally black type liquid crystal panel, and the auto light-shading system may further include a micro control unit connected to the photovoltaic module and the liquid crystal panel. The auto light-shading system can further include a regulator connected to the photovoltaic module and the light-shading device. The electric power can be transmitted to the light-shading device via the regulator. The auto light-shading system can further include a power storage connected to the regulator. A part of the electric power can be transmitted to the light-shading device via the regulator, and another part of the electric power can be transmitted to the power storage via the regulator.

The photovoltaic module of the auto light-shading system can provide electric power to driven the light-shading device, and the light transmittance of the light-shading device is determined by the output power of the photovoltaic module, which is related to the intensity of sunlight. The power supply to driven the light-shading device and the sunlight detector to determined the intensity of sunlight can be integrated in the photovoltaic module. The light transmittance of the light-shading device can be adjusted automatically by the output power of the photovoltaic module. The auto light-shading system can is be utilized in building-integrated photovoltaic (BIPV) field.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A and FIG. 1B are schematic diagrams of a first embodiment of the auto light-shading system of the invention;

FIG. 2 is a schematic diagram of a second embodiment of the auto light-shading system of the invention;

FIG. 3 is a schematic diagram of a third embodiment of the auto light-shading system of the invention; and

FIG. 4 is a schematic diagram of a fourth embodiment of the auto light-shading system of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

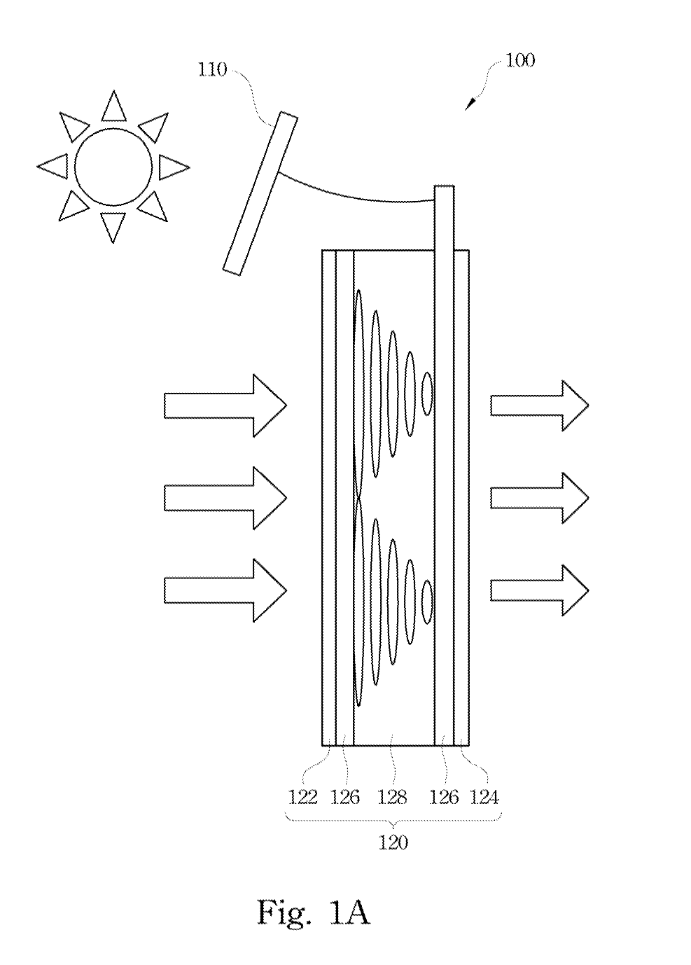

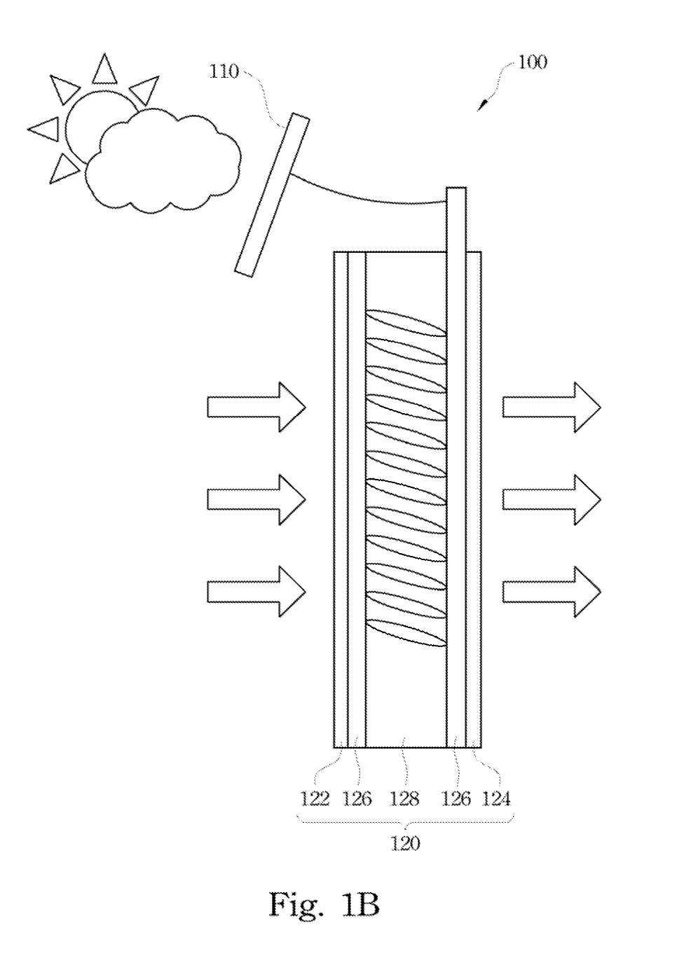

Refer to FIG. 1A and FIG. 1B. FIG. 1A and FIG. 1B are schematic diagrams of a first embodiment of the auto light-shading system of the invention. The auto light-shading system 100 includes a photovoltaic module 110, and a light-shading device 120 connected to the photovoltaic module 110. The photovoltaic module 110 may include at least one photovoltaic cell for providing an electric power. The photovoltaic module 110 is utilized for collecting a solar power and transforming the solar power into the electric power. The light-shading device 120 is driven by the electric power supplied by the photovoltaic module 110. The output power of the photovoltaic module 110 is related to the sun radiance, which is related to the light transmittance of the light-shading device 120. The light-shading device 120 is driven by the photovoltaic module 110, and the light transmittance of the light-shading device 120 can be controlled by the electric power of the photovoltaic module 110. Namely, the higher the output power of the photovoltaic module 110, the lower light transmittance of the light-shading device 120 would be.

The light-shading device 120 in this embodiment can be a liquid crystal panel. The liquid crystal panel of the light-shading device 120 includes a first polarizer 122, a second polarizer 124, two substrates 126, and a liquid crystal layer 128. The liquid crystal layer 128 is sandwiched and sealed between the to substrates 126. The first polarizer 122 and the second polarizer 124 are arranged at opposite sides of the substrates 126. The first polarizer 122 and the second polarizer 124 are arranged orthogonal. At least one of the substrates 126 is connected to the photovoltaic module 110; thereby the liquid crystal panel of the light-shading device 120 can be driven by the photovoltaic is module 110.

The liquid crystal panel of the light-shading device 120 has a white mode and a black mode determined by the voltage difference between the substrates 126, wherein the voltage difference between the substrates 126 is provided by the photovoltaic module 110. The twist angle of the liquid crystal material of the liquid crystal layer 128 is related to the voltage difference between the substrates 126.

The first polarizer 122 can only allow a light with linear polarization in a specific direction to pass. Only a linear polarized portion of the light can pass through the first polarizer 122. Therefore, after passing through the first polarizer 122, the light is linearly polarized in a specific direction and the light at this time is referred to as a first linearly polarized light. When the light passes through the liquid crystal layer 128, a main retardation occurs because of the birefringence and twist characteristics of a liquid crystal material. The light becomes an elliptically polarized light. The light has to become a second linearly polarized light in order to pass through the second polarizer 124. The liquid crystal panel of the light-shading device 120 of this embodiment is a normal white type liquid crystal panel.

Refer to FIG. 1A. When the weather is sunny, the sunlight provided to the photovoltaic module 110 is strong, the voltage difference is close to a predetermined value, the liquid crystal material would not lead the sunlight from the first polarizer 122 to the second polarizer 124, thereby the sunlight would be blocked by the second polarizer 124, and a black mode with low light transmittance is generated.

Refer to FIG. 1B. When the weather is cloudy, the sunlight provided to is the photovoltaic module 110 is limited, and the voltage difference is close to 0 volts, the sunlight would be lead from the first polarizer 122 to the second polarizer 124 by the twisted liquid crystal material of the liquid crystal layer 128 and could pass through the second polarizer 124, so that a white mode with high light transmittance is generated.

When the sunlight provided to the photovoltaic module 110 is between the sunlight provided in FIG. 1A and FIG. 1B, the voltage difference is between 0 volts and the predetermined value, so that the light would partially pass through the second polarizer 124, thus the light transmittance of the light-shading device 120 would be between the light transmittance in FIG. 1A and FIG. 1B.

According to the above description, the intensity of sunlight is related to the weather, the output power of the photovoltaic module 110 is related to the intensity of sunlight, which is further related to voltage difference between the substrates 126. The twist angle of the liquid crystal material in the liquid crystal layer 128 is related to the voltage difference between the substrates 126. The light transmittance of sunlight passing the second polarizer 124 is related to the twist angle of the liquid crystal material in the liquid crystal layer 128. Namely, the light transmittance of the light-shading device 120 could be determined by the output power of the electric power of the photovoltaic module to 110, wherein the output power of the photovoltaic module is related to the intensity of sunlight, thereby the transmission of the light-shading device 120 can be determined by the intensity of sunlight.

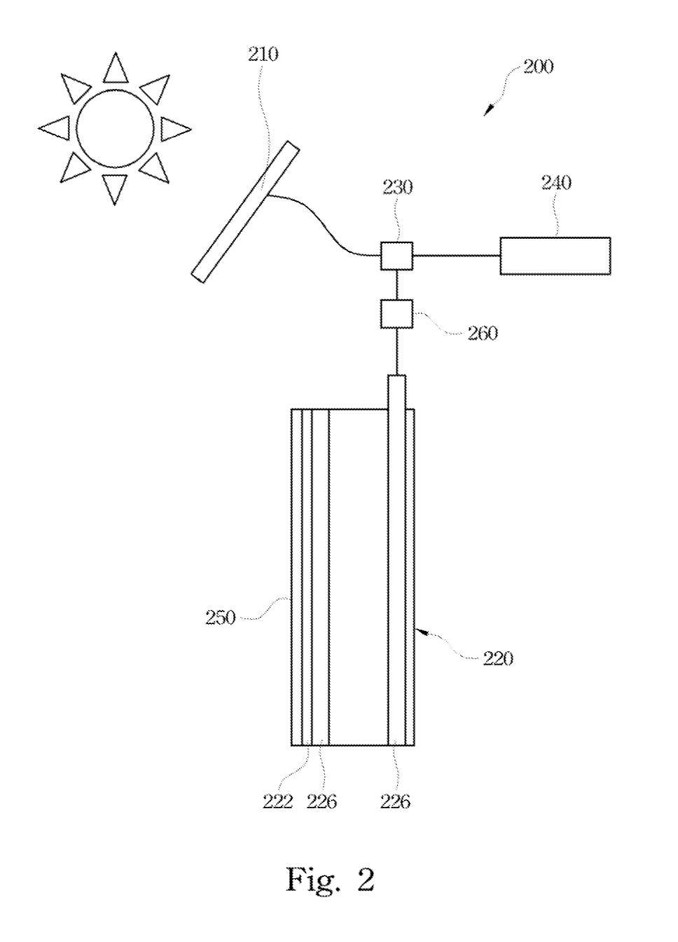

Refer to FIG. 2. FIG. 2 is a schematic diagram of a second embodiment of the auto light-shading system of the invention. The auto light-shading system 200 includes a photovoltaic module 210, a light-shading device 220, and a regulator 230. The regulator 230 is connected to the photovoltaic module 210. The electricity power provided by the photovoltaic module 210 is transmitted to the light-shading device 220 via the regulator 230. The light-shading device 220 of this embodiment is a liquid crystal panel, which can be a normal white type liquid crystal panel or a normal black type liquid crystal type liquid crystal panel.

The auto light-shading system 200 further includes a power storage 240 connected to the regulator 230. A part of the electricity power provided by the photovoltaic module 210 is transmitted to the light-shading device 220 via the regulator 230, and another part of the electricity power is transmitted to and stored in the power storage 240 via the regulator 230.

The auto light-shading system 200 further includes a UV filter 250. The UV filter 250 can be applied on the liquid crystal panel of the light-shading device 220. The UV filter 250 is applied on the first polarizer 222 of the liquid crystal panel of the light-shading device 220.

The auto light-shading system 200 can be utilized in building-integrated photovoltaic (BIPV) field, such as the external wall of the building to highlight the environmental consciousness and the technology of the building. The substrates 226 of the liquid crystal panel of the light-shading device 220 can further have at least a pattern thereon. The pattern can be a logo or a cartoon pattern.

When the liquid crystal panel of the light-shading device 220 of this embodiment is a normally black type liquid crystal panel, the auto light-shading system 200 can further include a micro control unit 260 connected to the photovoltaic module 210. The micro control unit 260 can determined the intensity of sunlight by the output power of the photovoltaic module 210 and determined the light transmittance of the light-shading device 200, wherein the normally black type liquid crystal panel of the light-shading device 220 is driven by the power stored in the power storage 240.

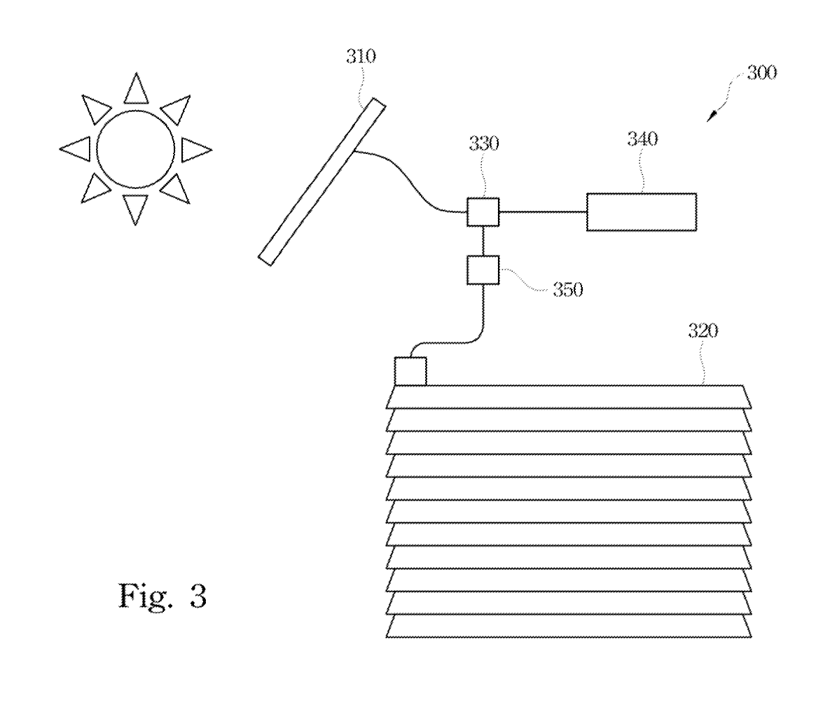

Refer to FIG. 3. FIG. 3 is a schematic diagram of a third embodiment of the auto light-shading system of the invention. The auto light-shading system 300 includes a photovoltaic module 310 and a light-shading device 320. The light-shading device 320 of this embodiment is an electric blind. The auto light-shading system 300 includes a regulator 330 and a power storage 340. A part of the electric power provided by the photovoltaic module 310 is transmitted to the light-shading device 320 via the regulator 330, and another part of the electric power is stored in the power storage 340. The electric blind of the light-shading device 320 is driven by the power supplied by the photovoltaic module 310. The auto light-shading system 300 can further include a micro control unit 350 to determine the intensity of sunlight by the output power of the photovoltaic module 310 to determine the light transmittance of the electric blind of the light-shading device 320.

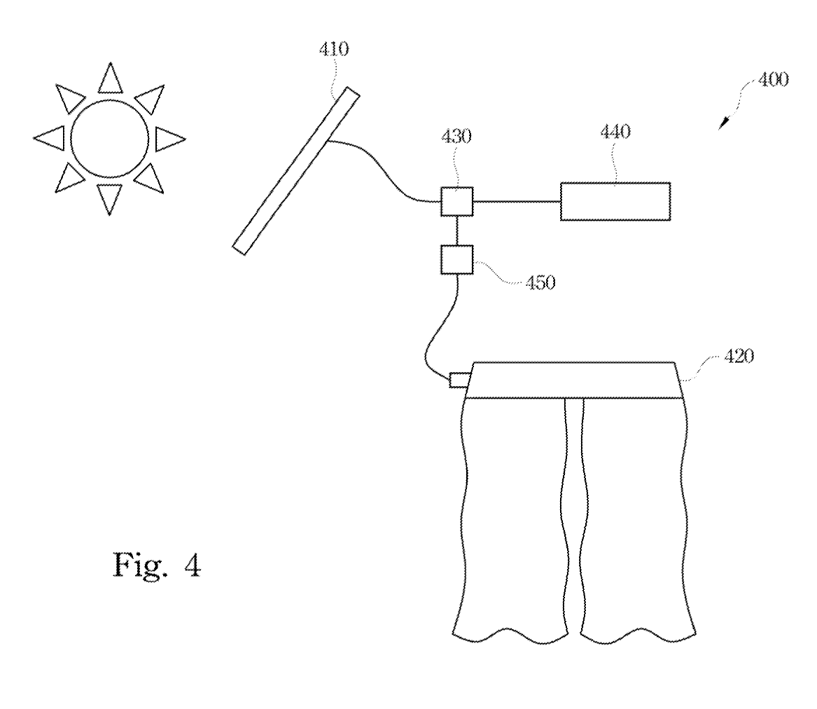

Refer to FIG. 4. FIG. 4 is a schematic diagram of a fourth embodiment of the auto light-shading system of the invention. The auto light-shading system 400 includes a photovoltaic module 410 and a light-shading device 420. The light-shading device 420 of this embodiment is an electric curtain. The auto light-shading system 400 includes a regulator 430 and a power storage 440. A part of the electric power provided by the photovoltaic module 410 is transmitted to the light-shading device 420 via the regulator 430, and another part of the electric power is stored in the power storage 440. The electric curtain of the light-shading device 420 is driven by the power supplied by the photovoltaic module 410. The auto light-shading system 400 can further include a micro control unit 450 to determine the intensity of sunlight by the output power of the photovoltaic module 410 to determine the light transmittance of the electric curtain of the light-shading device 420.

The photovoltaic module of the auto light-shading system can provide electric power to driven the light-shading device, and the light transmittance of the light-shading device is determined by the output power of the photovoltaic module, which is related to the intensity of sunlight. The power supply to driven the light-shading device and the sunlight detector to determined the intensity of sunlight can be integrated in the photovoltaic module. The light transmittance of the light-shading device can be adjusted automatically by the output power of the photovoltaic module. The auto light-shading system can be utilized in building-integrated photovoltaic (BIPV) field.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An auto light-shading system comprising:
a photovoltaic module for providing an electric power; and
a light-shading device connected to and driven by the photovoltaic module, wherein a light transmittance of the light-shading device is determined by an output power of the electric power of the photovoltaic module.

2. The auto light-shading system of claim 1, further comprising a regulator connected to the photovoltaic module and the light-shading device, wherein the electric power is transmitted to the light-shading device via the regulator.

3. The auto light-shading system of claim 2, further comprising a power storage connected to the regulator, wherein a part of the electric power is transmitted to the light-shading device via the regulator, and another part of the electric power is transmitted to the power storage via the regulator.

4. The auto light-shading system of claim 1, wherein the light-shading device is an electric blind, an electric curtain, or a liquid crystal panel.

5. An auto light-shading system comprising:
a photovoltaic module for providing an electric power;
a liquid crystal panel connected to and driven by the photovoltaic module, wherein a light transmittance of the light-shading device is determined by an output power of the electric power of the photovoltaic module; and
a UV filter applied on the liquid crystal panel.

6. The auto light-shading system of claim 5, wherein the liquid crystal panel comprises a first polarizer, a second polarizer, two substrates, and a liquid crystal layer; the liquid crystal layer is sandwiched between the substrates, and the first and second polarizers are arranged at opposite sides of the substrates.

7. The auto light-shading system of claim 6, wherein at least one of the substrate is connected to the photovoltaic module.

8. The auto light-shading system of claim 6, wherein each substrate comprises a pattern.

9. The auto light-shading system of claim 5, wherein the liquid crystal panel is a normally white type liquid crystal panel.

10. The auto light-shading system of claim 5, wherein the liquid crystal panel is a normally black type liquid crystal panel, and the auto light-shading system comprises a micro control unit connected to the photovoltaic module and the liquid crystal panel.

11. The auto light-shading system of claim 5, further comprising a regulator connected to the photovoltaic module and the light-shading device, wherein the electric power is transmitted to the light-shading device via the regulator.

12. The auto light-shading system of claim 11, further comprising a power storage connected to the regulator, wherein a part of the electric power is transmitted to the light-shading device via the regulator, and another part of the electric power is transmitted to the power storage via the regulator.
